(19) United States
(12) Patent Application Publication
(10) Pub. No.: US 2013/0209845 A1
(43) Pub. Date: Aug. 15, 2013

(54) ELECTROCHEMICAL CELL HAVING AT LEAST ONE PRESSURE RELIEF MEANS

(71) Applicants: Tim Schaefer, Harztor (DE); Erhard Schletterer, Dresden (DE)

(72) Inventors: Tim Schaefer, Harztor (DE); Erhard Schletterer, Dresden (DE)

(73) Assignee: Li-Tec Battery GmbH, Kamenz (DE)

(21) Appl. No.: 13/817,332

(22) PCT Filed: Aug. 12, 2011
(86) PCT No.: PCT/EP2011/004069

§ 371 Date: May 1, 2013

(30) Foreign Application Priority Data
Aug. 17, 2010 (DE) 10 2010 034 543.1

(51) Int. Cl. H01M 10/52

(52) U.S. Cl. CPC H01M 10/52
USPC 429/61; 429/82

(57) ABSTRACT

An electrochemical cell comprises an electrode stack (10), at least one current conductor (12, 14) connected to the electrode stack (10), and a casing (20, 22) which at least partially encloses the electrode stack (10). The at least current conductor (12, 14) extends at least partially out of the casing (20, 22), and the casing (20, 22) is provided with at least one pressure relief means (26, 28, 30). It is advantageous for protecting the electronics and the environment of the electrochemical cell that the at least one pressure relief means (26, 28, 30) is disposed preferably remotely from the at least one current conductor (12, 14) as possible and preferably in a lower area of the casing (20, 22) when the electrochemical cell is in the installed state.

The present invention relates to an electrochemical cell for a battery assembly, in particular an electrochemical cell having at least one pressure relief means.

Batteries (primary storage means) and accumulators (secondary storage means) which are composed of one or more storage cells in which electrical energy is converted into chemical energy in or between an electrolyte in an electrochemical charging reaction between a cathode and an anode and thus stored when a charging current is applied, and in which chemical energy is converted into electrical energy in an electrochemical discharging reaction when an electrical load is connected, are known as electrochemical energy storage apparatus. Primary storage means are thereby as a rule only charged once and then discarded after being discharged, while secondary storage means allow a plurality of charging and discharging cycles (from several 100 to more than 10,000). It should be noted in this context that accumulators are also called batteries, particularly in the automotive sector.

The present invention will be described in conjunction with lithium ion batteries for supplying vehicle drive systems. It is however pointed out that the invention can also find use independently of the chemistry and the design of the electrochemical cell and the battery and also independently of the type of drive system to be supplied.

Electrochemical cells comprising an electrode stack which is at least partially enclosed by a casing are known from the prior art. The casing is on the one hand intended to prevent chemicals from escaping the electrode stack into the environment and, on the other, to protect the cell's components from undesired interaction with the environment, for instance with water or water vapor.

Upon high load or overload, e.g. in the case of excess charging or a short circuit, in case of damage or even in normal operation given high overheating from outside, such electrochemical cells or storage means respectively can reach a thermally overheated state which generates an increased internal cell pressure potentially leading to bursting, igniting or exploding of the cell and the housing. There is a particular hazard specifically in the case of lithium batteries or lithium ion batteries, since such batteries contain liquid, flammable, organic electrolytes which can thereby escape.

A flat-type lithium ion battery is known from DE 10 2007 063 193 A1 which exhibits a housing frame having a lateral pressure relief apparatus in the form of a breaking region so as to enable lateral pressure relief and gas discharge to the outside in critical overpressure situations.

Further, there are known electrochemical cells in which a pressure relief means is mounted in the vicinity of the current conductors or laterally in the sealing seam of the cell's casing, wherein the pressure relief means is formed e.g. by means of inserted elements of a low melting point as a local weakening of the sealing seam. Reference is made by way of example in this respect to KR 10 2009 0076343 A, U.S. 2003/0148173 A1, U.S. Pat. No. 7,122,276 B2, U.S. 2010/0112436 A1 and WO 2009/078604 A2.

The invention is based on the object of providing an improved electrochemical cell which allows for safely relieving internal cell pressure when needed.

According to the invention, this object is achieved by the teaching of the independent claims. Preferable further developments of the invention are the subject matter of the dependent claims.

According to the invention, an electrochemical cell is provided which comprises an electrode stack, at least one current conductor connected to the electrode stack, and a casing which at least partially encloses the electrode stack. The at least one current conductor in this case extends at least partially out of the casing and the casing is provided with at least one pressure relief means. Advantageously, the at least one current conductor extends out of the casing in a first area thereof and the at least one pressure relief means is disposed in a second area of the casing facing away from the first area.

According to the invention, an electrochemical cell is also provided which comprises an electrode stack, at least one current conductor connected to the electrode stack, and a casing which at least partially encloses the electrode stack. The at least one current conductor extends at least partially out of the casing and the casing is provided with at least one pressure relief apparatus. Advantageously, said at least one pressure relief apparatus is disposed in a lower area of the casing when the electrochemical cell is in the installed state.

According to the invention, an electrical energy storage apparatus or battery assembly respectively, having at least one such electrochemical cell is further provided.

In accordance with the invention, the at least one current conductor extends out of the casing in a first area thereof and the at least one pressure relief means is disposed in a second area of the casing facing away from the first area and/or the at least one pressure relief means is disposed in a lower area of the casing when the electrochemical cell is in the installed state. In other words, the at least one pressure relief means is preferably arranged far (away) from the current conductors and/or in the lower region of the cell.

Problems exist specifically in the case of lithium ion batteries in the automotive sector in that a battery management system and/or further electronic components is/are accommodated in the battery housing in the area of the cell's current conductors and the battery is often mounted underneath a passenger cabin or below a passenger seat within the motor vehicle. Thereby, it should be taken into account that the cells are usually installed in the battery housing and the battery is mounted in the motor vehicle such that the current conductors protrude out of the cell casing from an upper area of the cell.

The electrochemical cell according to the invention is coupled with the advantages of the pressure relief and material discharge by the at least one pressure relief means (also called “venting”) not occurring either in the area of the current conductors and the battery management system nor in a direction toward the passenger cabin upon increased pressure and/or increased temperature inside the cell. The battery's operational safety and the passengers' safety can thereby be increased when a critical pressure or temperature condition occurs within an electrochemical cell. In particular, short circuits in the area of the current conductors caused by electrically conductive venting gases or electrolytes can thereby be prevented.

Any type of energy storage means from which electrical energy can be extracted, wherein an electrochemical reaction takes place inside the energy storage means, should be understood as an “electrochemical energy storage apparatus” in the present case. The term includes energy storage means of all types, in particular primary and secondary batteries. The electrochemical energy storage apparatus has at least one electrochemical cell, preferably a plurality of electrochemical cells. The plurality of electrochemical cells can be connected in parallel to store a greater charging volume or in series to obtain a desired operating voltage, or can form a combination parallel/series connection.

An “electrochemical cell” or “electrochemical energy storage cell” is to be understood in the present case as an apparatus which serves the purpose of emitting electrical energy, wherein the energy is stored in a chemical form. In the case of rechargeable secondary batteries, the cell is also configured to absorb energy, convert it into chemical energy and store it. The design (i.e. particularly the size and geometry) of an electrochemical cell can be selected as a function of the available space. The electrochemical cell is preferentially formed to be substantially prismatic or cylindrical.

An “electrode stack” in this context is to be understood as an arrangement of at least two electrodes and an interposed electrolyte. The electrolyte can be partially received by a separator, wherein the separator then separates the electrodes. The electrode stack preferably has a plurality of electrode and separator layers, wherein the electrodes of like polarity are each preferably electrically interconnected, particularly connected in parallel. The electrodes are of e.g. plate-like or film-like design and are preferably arranged substantially parallel to one another (prismatic energy storage cells). The electrode stack can also be coiled and have a substantially cylindrical shape (cylindrical energy storage cells). The term “electrode stack” is also intended to include such electrode coils. The electrode stack can comprise lithium or another alkali metal, also in ionic form.

In the context of the present invention, an electrically conductive structural element of an electrochemical cell serving to transport electrical energy into or out of the cell should be understood as being a “current conductor.” Electrochemical cells usually have two types of current conductors in respective electrically conductive connection with one of the two electrodes or electrode groups—anodes or cathodes—inside the cell. In other words, each electrode of the cell's electrode stack has its own current conductor, respectively the electrode stack's electrodes of like polarity are connected to a common current conductor. The design of the current conductor is adapted to the design of the electro-chemical cell, its electrode stack respectively.

The term “casing” is intended to include any type of apparatus suited to preventing chemicals from escaping into the environment from the electrode stack and protecting the components of the electrode stack from harmful external influences. The casing can be formed from one or more molded part(s) and/or be of film-like design. Furthermore, the casing can be of single-layer or multi-layer configuration. The casing can additionally be manufactured from a substantially rigid material or from an elastic material. The casing is preferably formed from a gas-tight and electrically insulating material or layered composite. The casing preferably encloses the electrode stack without gaps or air cushions so as to enable good thermal conduction between the casing and the inside of the electrochemical cell.

All types of apparatus which are suited to allow for pressure to be dissipated with or without material discharge from the cell in the event of the pressure and/or temperature increasing inside the electrochemical cell (e.g. due to overload or the like) are intended to be understood as “pressure relief means” within the framework of the present invention. It is expressly pointed out that the present invention is not limited to specific types of pressure relief means, rather the invention is directed toward the positioning of said at least one pressure relief means of any given type. In the case of two or more pressure relief means on one electrochemical cell, same can be of the same type or can also differ from one another.

The “first area,” “second area” and “lower area” of the casing or electrochemical cell also include, apart from the respective edge portion of the casing or cell, a portion adjacent said edge portion towards the opposite edge portion. Selecting the precise positioning of the at least one pressure relief means within the cited regions is particularly based on the target to be achieved, namely the pressure relief ensuing neither into the area of the current conductors nor toward a passenger cabin.

The following will describe further preferred developments of the invention.

Advantageously, the at least one current conductor extends out of the casing in a first half thereof and the at least one pressure relief means is disposed in a second half of the casing. The at least one current conductor preferably extends out of the casing at an upper third or quarter thereof and the at least one pressure relief means is disposed in a lower third or quarter of the casing.

In one advantageous configuration, the at least one current conductor extends out of the casing at a first narrow side thereof (the upper narrow side in particular) and at least one pressure relief means is disposed at a second narrow side (the lower narrow side in particular) opposite the casing's first narrow side.

In a further advantageous configuration of the invention, the at least one current conductor extends out of the casing at a first narrow side thereof (the upper narrow side in particular) and at least one pressure relief means is disposed at a third narrow side extending substantially transverse to the casing's first narrow side in order to effect lateral pressure relief.

In still another advantageous configuration of the invention, at least one pressure relief means is disposed on a main side of the casing.

In the case of two or more pressure relief means, the three above-cited advantageous configuration can optionally be combined with one another. Pressure relief means are thus preferably provided at the lower narrow side and at one or both of the lateral narrow sides. It is likewise preferential to provide two or more pressure relief means at the lower narrow side.

The pressure relief means are preferably disposed in the area of a sealing seam of the casing. Similarly, the pressure relief means are preferably disposed within the material or material structure of the casing itself.

The at least one pressure relief means is advantageously configured to be a passive pressure relief means.

Likewise advantageously, the electrochemical cell is provided with at least one measuring device and the at least one pressure relief means is then configured as an active pressure relief means. The measuring device can be of any type; in the present context, it is of a general configuration so as to identify the need for pressure relief. Preferably, the measuring device is designed to detect pressure and/or temperature, in particular a pressure and/or temperature increase inside the electrochemical cell.

Suitable examples of a pressure relief means which can be used in an electro-chemical cell according to the present invention are bursting devices (e.g. rupture disks, safety membranes and film, predetermined breaking points), local weakening of the casing and/or sealing seam (e.g. by weakening of the material or material structure or by introducing additional members into the material or material structure or by specific design), overpressure relief valves, means to locally destroy the casing and/or sealing seam (e.g. cutting means, piercing means, tearing means, etc.) and the like.

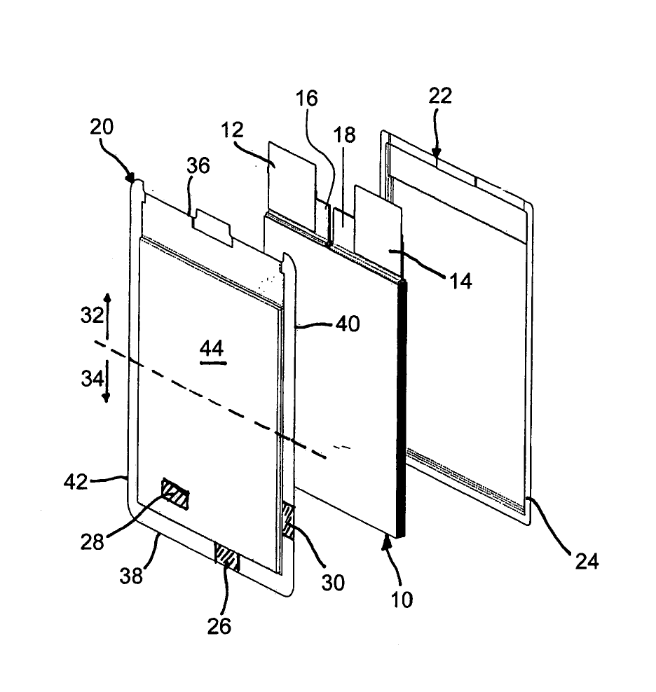

Further advantages, features and applicational possibilities for the present invention will be yielded from the following description of preferred exemplary embodiments in conjunction with the drawing. Therein, the sole FIG. 1 shows a schematic exploded view of an electrochemical cell according to the present invention with various positioning options for the one or more pressure relief apparatus.

FIG. 1 shows an exploded view of an electrochemical cell having an electrode stack 10 which exhibits several electrode layers and interposed separators. Two current conductors 12 and 14 are connected (mechanically and electrically conducting) to said electrode stack 10 via respective electrode arrays 16 respectively 18 of electrodes of like polarity.

The electrode stack 10 is enclosed on both sides by a film-like casing 20, 22, wherein the two casing films 20 and 22 are interconnected so as to be fluid-tight at the narrow sides 36-42 of the electrode stack 10, or the cell respectively, by means of a sealing seam 24. The two current conductors 12 and 14 protrude out of the casing 20, 22 through the sealing seam 24 at the upper narrow side 26 so that same can contact and be connected to the battery terminals outside of the cell.

FIG. 1 shows the electrochemical cell substantially in the orientation in which it will also be installed in the battery and ultimately in e.g. a motor vehicle. The electrochemical cell or casing 20, 22, respectively, thus has an upper half 32, a lower half 34, a first upper narrow side 36, a second lower narrow side 38, two third lateral narrow sides 40 and 42, and two main sides 44.

The casing 20, 22 of the thus constructed electrochemical cell is provided with at least one pressure relief means 26-30. Preferably, the casing 20, 22 is equipped with one, two, three or four pressure relief means 26-30.

Thus, for example, one, two or three pressure relief means 26 can be provided at the lower narrow side 38 of the casing 20, 22 in the area of sealing seam 24.

Alternatively or additionally thereto, one or two pressure relief means 28 can be provided in each case in the area of the sealing seam 24 at the lower area 34 on one or both lateral narrow side(s) 40, 42 of the casing 20, 22.

Further alternatively or additionally, one or more pressure relief means 30 can also be provided on one or both main sides 34 of the casing 20, 22 in lower area 34.

1. A prismatic electrochemical cell comprising:
an electrode stack;
two current conductors connected to the electrode stack; and
a casing which at least partially encloses the electrode stack,
wherein the current conductors extend at least partially out of the casing and the casing is provided with at least one pressure relief means,
wherein the current conductors extend out of the casing in a first area thereof at a first narrow side of the casing, and the at least one pressure relief means is disposed in a second area of the casing facing away from the first area at a second narrow side of said casing opposite to said first narrow side or at a main side of the casing.

2. The prismatic electrochemical cell according to claim 1, wherein the second area of the casing is disposed at a bottom relative the first area of the casing when the electrochemical cell is in an installed state.

3. A prismatic electrochemical cell comprising:
an electrode stack;
at least one current conductor connected to the electrode stack; and
a casing which at least partially encloses the electrode stack, wherein the at least one current conductor extends at least partially out of the casing and the casing is provided with at least one pressure relief means,
wherein the at least one pressure relief means is disposed in a lower area of the casing when the electrochemical cell is in an installed state.

4. The prismatic electrochemical cell according to claim 3, wherein the at least one current conductor extends out of the casing in a first area thereof and the at least one pressure relief means is disposed in a second area of the casing facing away from the first area.

5. The prismatic electrochemical cell according to claim 3, wherein the at least one current conductor extends out of the casing in a first half thereof and the at least one pressure relief means is disposed in a second half of the casing.

6. The prismatic electrochemical cell according to claim 3, wherein the at least one current conductor extends out of the casing at a first narrow side thereof and at least one pressure relief means is disposed at a second narrow side of the casing opposite the first narrow side.

7. The prismatic electrochemical cell according to claim 3, wherein the at least one current conductor extends out of the casing at a first narrow side thereof and at least one pressure relief means is disposed at a third narrow side of the casing extending substantially transverse to the first narrow side.

8. The prismatic electrochemical cell according to claim 1, wherein at least one pressure relief means is disposed on a main side of the casing.

9. The prismatic electrochemical cell according to claim 1, wherein the at least one pressure relief means is configured as a passive pressure relief means.

10. The prismatic electrochemical cell according to claim 1, wherein the electrochemical cell is provided with at least one measuring device and the at least one pressure relief means is configured as an active pressure relief means.

11. An electrochemical energy storage apparatus comprising at least one prismatic electrochemical cell in accordance with claim 1.

12. A prismatic electrochemical cell, comprising:
an electrode stack;
two current conductors connected to said electrode stack; and
a casing which at least partially encloses said electrode stack, wherein said current conductors extend at least partially out of said casing and said casing is provided with at least one pressure relief means,
wherein said current conductors extend out of said casing in a first area thereof at a first narrow side of said casing and said at least one pressure relief means is disposed in a second area of said casing facing away from said first area, and
said at least one pressure relief means is configured as an active pressure relief means, and said electrochemical cell is provided with at least one measuring device to identify a need for pressure relief.

13. A motor vehicle having at least one electrochemical energy storage apparatus comprising at least one prismatic electrochemical cell, wherein the prismatic electrochemical cell includes:
an electrode stack;
two current conductors connected to the electrode stack; and
a casing which at least partially encloses said electrode stack, wherein said current conductors at least partially extend out of said casing and said casing is provided with at least one pressure relief means,
wherein said current conductors extend out of said casing in a first area thereof at a first narrow side of said casing, and
wherein said at least one pressure relief means is disposed in a second area of said casing facing away from said first area at a second narrow side of said casing that is opposite to said first narrow side or in a second area of said casing facing away from said first area at a main side of said casing or at a bottom relative to said first area when installed.
